(19) United States
(12) Patent Application Publication
(10) Pub. No.: US 2012/0008055 A1
(43) Pub. Date: Jan. 12, 2012

(54) Autostereoscopic Display Device

(75) Inventor: Chao Ping Chen, Kunshan (CN)

(73) Assignee: INFOVISION OPTOELECTRONICS (KUNSHAN) CO., LTD., Kunshan (CN)

(21) Appl. No.: 12/884,067

(22) Filed: Sep. 16, 2010

(30) Foreign Application Priority Data
Jul. 9, 2010 (CN) 201010222373.5

(51) Int. Cl. G02F 1/1335; H04N 13/04

(52) U.S. Cl. 349/15; 348/51; 348/E13.026

(57) ABSTRACT

An autostereoscopic display device includes a display panel and a backlight source, in which the display panel includes an upper substrate and a lower substrate disposed opposite to each other, and a liquid crystal layer between the upper substrate and the lower substrate and having a plurality of liquid crystal molecules. The backlight source is to provide light to the display panel. The display panel includes a plurality of pixel units and each pixel unit includes a first sub-pixel unit and a second sub-pixel unit. Liquid crystal molecules in the first sub-pixel unit have an opposite alignment direction with respect to liquid crystal molecules in the second sub-pixel unit. And the light is emerged in a first direction after passing through the liquid crystal molecules in the first sub-pixel unit of the display panel and is emerged in a second direction after passing through the liquid crystal molecules in the second sub-pixel unit. The resulting device can reduce crosstalk of displayed images.

### CROSS REFERENCE TO RELATED APPLICATION

This application claims the benefit of priority from Chinese Patent Application No. 201010222373.5 filed on Jul. 9, 2010, the entire content of which is hereby incorporated by reference.

### FIELD OF THE TECHNOLOGY

The present invention relates to 3-dimensional (3D) stereoscopic display technologies, and more particularly, to an autostereoscopic display device with suppressed crosstalk effect.

### BACKGROUND OF THE INVENTION

With the increases in size and resolution of televisions (TVs), High Definition TVs (HDTV) are increasingly aimed at providing more realistic scenes to viewers.

It has been known that the realistic world is 3D stereoscopic. The 3D vision of a human relies heavily on two eyes, which look at the surrounding world from slightly different directions. The offset generated by two eyes, or generated by an interpupillary distance, is individual and varies considerably. A mean adult interpupillary distance is estimated to be around 65 mm. This creates two different retinal images with slightly parallax perspectives that the brain further fuses into a stereoscopic image for the viewer.

In recent years, with the development of the HDTV, people are looking for techniques that can display more realistic scenes, more readily. According to the 3D stereoscopic imaging principle, two images slightly parallax, i.e., a left image and a right image, are respectively provided to the left eye and the right eye through a display. Thus, a 3D sense is obtained. Current popular autostereoscopic displays mainly include barrier-based autostereoscopic display devices and lenticular-based autostereoscopic display devices. With an autostereoscopic display device, a viewer needs not wear a viewing-assistant device (e.g. a pair of glasses, a head mounted display etc.). A signal processing unit, e.g., a Graphic Processing Unit (GPU) of the autostereoscopic display device delivers at least two slightly parallax images of the same scene to a display screen. Then, through optical functions of a barrier array or a lenticular array configured in front of the display screen, the two slightly parallax images, acting as the left image and the right image are respectively received by the left eye and the right eye of the viewer. Then, a stereoscopic view is sensed after the further fusing operation of the brain of the viewer.

However, for traditional autostereoscopic display devices, there will be light leakage between the left image and the right image, i.e., light illuminating the left image may partly enter the right eye of the viewer, or light illuminating the right image may partly enter the left eye of the viewer, as shown in FIG. 1. FIG. 1 is a schematic diagram illustrating light leakage of a conventional autostereoscopic display device. Left image 1 and right image 2 are arranged alternatively on the display screen. A backlight (not shown in FIG. 1) behind the display screen emits light to illuminate the left image 1 and the right image 2 on the display screen. Through refraction function of a lenticular array 5 (containing multiple lens units) in front of the display screen, the light illuminating the left image 1 and the light illuminating the right image 2 mainly emerge as light 3 in a first direction and as light 4 in a second direction. The light 3 in the first direction and the light 4 in the second direction respectively enter the left eye and the right eye of the viewer. But due to restrictions of traditional autostereoscopic display techniques, part of the light, e.g. a leakage light (as shown by 3′ in FIG. 1) illuminating the left image 1 may enter into the right eye approximately in the second direction after the refraction of the lenticular array 5. Or, a leakage light (as shown by 4′ in FIG. 1) illuminating the right image 2 may enter into the left eye approximately in the first direction after the refraction of the lenticular array 5. The leakage light is referred to as crosstalk, resulting in a problem where, to some degree, the left image may be seen by the right eye and vice versa. Similarly, this is also unavoidable for barrier-based autostereoscopic display devices. The crosstalk affects display quality of 3D images severely and causes visual fatigue to the viewer. Therefore, there is a need in the field to address the shortcomings of conventional systems.

### SUMMARY OF THE INVENTION

An autostereoscopic display device is provided so as to reduce crosstalk in an image.

According to an aspect of the present invention, an autostereoscopic display device includes a display panel and a backlight source, in which
the display panel includes an upper substrate and a lower substrate disposed opposite to each other, and a liquid crystal layer between the upper substrate and the lower substrate and comprising a plurality of liquid crystal molecules;
the backlight source is adapted to provide light to the display panel;
the display panel includes a plurality of pixel units and each pixel unit includes a first sub-pixel unit and a second sub-pixel unit;
liquid crystal molecules in the first sub-pixel unit have an opposite alignment direction with respect to liquid crystal molecules in the second sub-pixel unit; and
the light is emerged in the first direction after passing through the liquid crystal molecules in the first sub-pixel unit of the display panel and is emerged in a second direction after passing through the liquid crystal molecules in the second sub-pixel unit.

It can be seen from the above technical solution that, in the autostereoscopic display device provided, each pixel unit of the display panel is divided into two sub-pixel units; and liquid crystal molecules in the two sub-pixel units have opposite alignment directions. Thus, after appropriate voltage is applied to the autostereoscopic display device, the backlight diverges into two directions after passing through the liquid crystal molecules of the two sub-pixel units, which effectively reduces light leakage between different sub-pixel units. The prior art situation that light emitting from one sub-pixel unit emerges in all directions, i.e., the problem that part of the light emitting from one sub-pixel unit will enter into the left eye and the right eye of the viewer at the same time, will not occur. Therefore, the crosstalk is effectively suppressed and visual fatigue of the viewer is reduced.

As to a display panel with an In-Plane Switching (IPS) structure, since the liquid crystal molecules have a pretilt angle, when no voltage is applied to the liquid crystal layer, the backlight will diverge into two directions after passing through the liquid crystal molecules of the two sub-pixel units, which can effectively reduce the light leakage among different sub-pixel units thereby avoiding crosstalk.

### BRIEF DESCRIPTION OF THE DRAWINGS

FIG. 1 is a cross-sectional view schematically illustrating light leakage of a conventional autostereoscopic display device.

FIG. 2 is a cross-sectional view schematically illustrating a display panel in an autostereoscopic display device according to a first example of the present invention.

FIG. 3 is a schematic diagram illustrating an optical effect of the display panel of the autostereoscopic display device according to the first example of the present invention.

FIG. 4 is a schematic curve diagram illustrating a relation between voltage applied to the display panel of the autostereoscopic display device and transmittance according to the first example of the present invention.

FIG. 5a and FIG. 5b are schematic diagrams illustrating operational principle of the autostereoscopic display device according to the first example of the present invention when null voltage and an adequate voltage are applied to the display panel thereof.

FIG. 6 is a schematic diagram illustrating a simulated effect of the autostereoscopic display device according to the first example of the present invention.

FIG. 7a and FIG. 7b are schematic diagrams illustrating working of an autostereoscopic display device according to a second example of the present invention when null voltage and an adequate voltage are applied to the display panel thereof.

### DETAILED DESCRIPTION

Specific examples of the invention will be described further in detail with reference to accompanying drawings, to make the above objectives, technical features and merits therein clearer.

A principle upon which the present invention relies is that, each pixel unit in an autostereoscopic display device is divided into two domains, i.e., a left sub-pixel unit and a right sub-pixel unit, in which liquid crystal molecules in the left sub-pixel unit and in the right sub-pixel unit have opposite alignment directions and therefore have opposite pretilt angles. When an appropriate voltage is applied to the liquid crystal layer, the liquid crystal molecules will rotate in opposite directions, which makes a left image in the left sub-pixel unit mainly received by a left eye of a viewer after being illuminated and makes a right image in the right sub-pixel unit mainly received by a right eye of the viewer after being illuminated at the same time. When the left sub-pixel unit and the right sub-pixel unit are provided with different image signals at the same time, an ideal 3D effect will be generated through further functions of a lenticular array or a barrier array disposed in front of a display panel. For this reason, image crosstalk is effectively reduced.

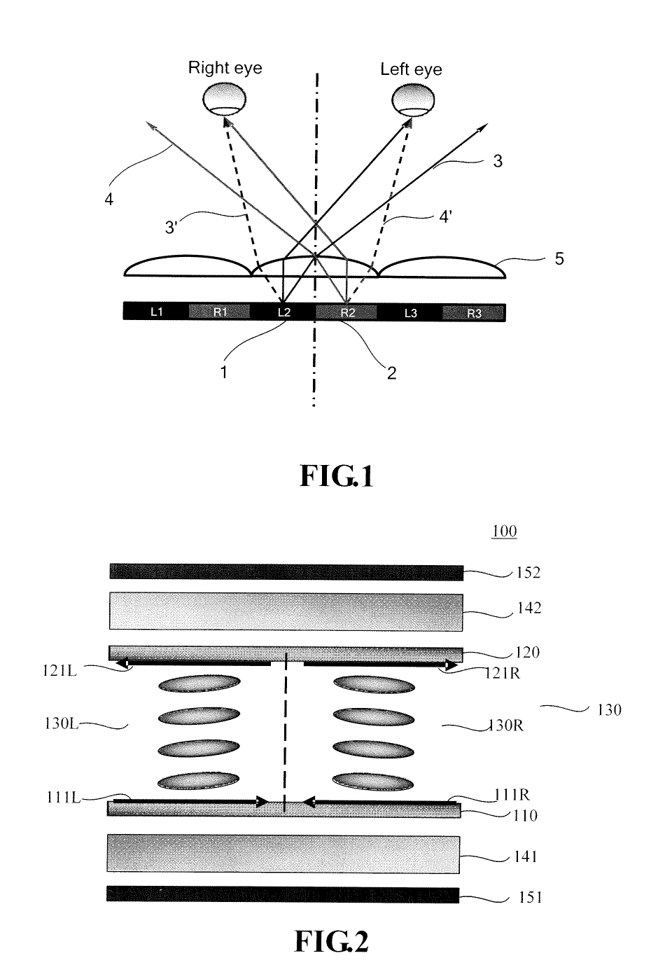

FIG. 2 is a cross-sectional view schematically illustrating a display panel in an autostereoscopic display device according to a first embodiment of the present invention. As shown in FIG. 2, the display panel 100 in the autostereoscopic display device according to a first example of the present invention includes a lower substrate 110, an upper substrate 120 and a liquid crystal layer 130 between the upper substrate 120 and the lower substrate 110. An exterior surface of the lower substrate 110 is sequentially configured with a first quarter wave plate 141 (also referred to as a lower quarter wave plate) and a first polarizer 151 (also referred to as a lower polarizer). An exterior surface of the upper substrate 120 is sequentially configured with a second quarter wave plate 142 (also referred to as an upper quarter wave plate) and a second polarizer 152 (also referred to as an upper polarizer). Further, the autostereoscopic display device also includes a backlight source (not shown in FIG. 2). The backlight source may be disposed behind or beside the display panel 100, and is adapted to emit light to the display panel 100. By way of example, the light source may be a Cold-Cathode Fluorescent Lamp (CCFL), an External Electrode Fluorescent Lamp (EEFL), or a light-emitting diode (LED) which is excellent in brightness and color saturation. Moreover, a surface of the lower substrate 110 of the display panel 100 facing the upper substrate 120 (also referred to as an interior surface of the lower substrate 110) is configured with a pixel electrode. A surface of the upper substrate 120 facing the lower substrate 110 (also referred to as an interior surface of the upper substrate 120) is configured with a common electrode. Furthermore, on the surface of the upper substrate 120 close to the liquid crystal layer 130 of the display panel 100 of the autostereoscopic display device, in this example, there is an upper alignment layer; and on a surface of the lower substrate 110 close to the liquid crystal layer 130, there is a lower alignment layer.

In the first example, the display panel 100 includes multiple pixel units. FIG. 2 shows a cross-sectional view of one pixel unit in the display panel 100. In FIG. 2, the pixel unit is divided into two domains, i.e., the pixel unit has a first sub-pixel unit and a second sub-pixel unit. In the illustrated examples, the first sub-pixel unit and the second sub-pixel unit may also be referred to as a left sub-pixel unit and a right sub-pixel unit. Liquid crystal molecules in left sub-pixel unit 130L and in right sub-pixel unit 130R have opposite alignment directions. The opposite alignment directions of the liquid crystal molecules are realized through coating alignment layers respectively on the surfaces of the upper substrate 120 and the lower substrate 110 close to the liquid crystal layer 130. As shown in FIG. 2, directions respectively indicated by arrows which are denoted by reference signs 121L and 121R (or, directions respectively indicated by arrows which are denoted by reference signs 111L and 111R in FIG. 2) respectively represent alignment directions of the alignment layers corresponding to the left sub-pixel unit 130L and the right sub-pixel unit 130R. The opposite alignment directions of the alignment layers corresponding to the left sub-pixel unit 130L and the right sub-pixel unit 130R make the liquid crystal molecules in the left sub-pixel unit 130L and in the right sub-pixel unit 130R have opposite alignment directions.

As to the processing of the alignment layers in the embodiment, it is possible to adopt conventional alignment processing techniques, i.e., to coat alignment materials such as fully imidized soluble polyimide on an upper surface of the lower substrate 110 and a lower surface of the upper substrate 120, then to adopt a rubbing processing method, i.e. rubbing baked alignment layers by a cloth wrapped on a metal roller, so as to make the liquid crystal molecules align to a desired direction. Preferably, there is a pretilt angle between an optical axis (OA) of the liquid crystal molecules in the display panel and a plane where the display panel is located. Since the liquid crystal molecules in the left sub-pixel unit 130L and in the right sub-pixel unit 130R have opposite alignment directions, the liquid crystal molecules in the left sub-pixel unit 130L and in the right sub-pixel unit 130R have opposite pretilt angles. The pretilt angle may be 2°, for example. Thus, in the sub-pixel unit such as the left sub-pixel unit 130L, in order to ensure that the liquid crystal molecules in the left sub-pixel unit 130L are parallel in the OA direction or in an opposite direction (here, it is possible to define that an arrangement status of the liquid crystal molecules with a pretilt angle of 2° is parallel in the OA of the liquid crystal molecules direction, whereas the arrangement status of the liquid crystal molecules with a pretilt angle of −2° is parallel in an opposite OA direction to the liquid crystal molecules of 2° pretilt angle), the alignment directions of the upper alignment layer and the lower alignment layer in the left sub-pixel unit 130L are opposite to each other, as shown by arrows which are represented by reference signs 121L and 111L in FIG. 2. The same principle applies to the right sub-pixel unit as well.

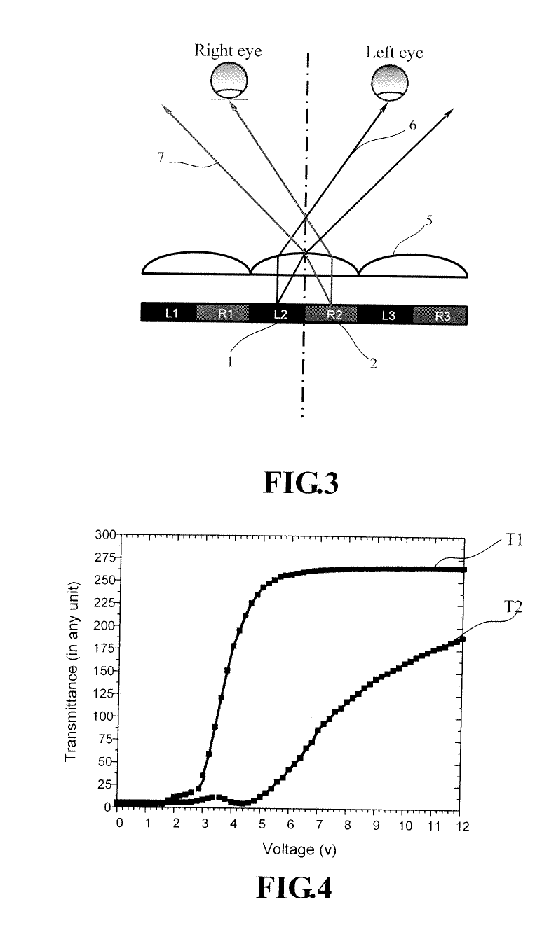

Further, the pixel electrode on the lower substrate 110 in the pixel unit shown in FIG. 2 is divided into a left sub-pixel electrode in the left sub-pixel unit and a right sub-pixel electrode in the right sub-pixel unit. In the autostereoscopic display device of the first embodiment, different signals are inputted into the left sub-pixel electrode and the right sub-pixel electrode. Different signals inputted into the left sub-pixel electrode and the right sub-pixel electrode respectively represent different image signals, e.g. left image signals L1, L2, L3 . . . received by the left eye of the viewer in FIG. 3 and right image signals R1, R2, R3 . . . received by the right eye. In addition, in order to realize the autostereoscopic display of the autostereoscopic display device of this example, the left image signals on the left sub-pixel electrode of the display panel and the right image signals on the right sub-pixel electrode of the display panel may be respectively inputted into the left sub-pixel electrode and the right sub-pixel electrode at the same time.

Preferably, the lower polarizer 151 is a 45° polarizer and the upper polarizer (often referred to as an analyzer) 152 is a 135° polarizer. The alignment direction of the liquid crystal layer is 0°, so as to ensure the best transmittance on the horizontal direction, i.e., the best stereoscopic effect in a left-to-right direction.

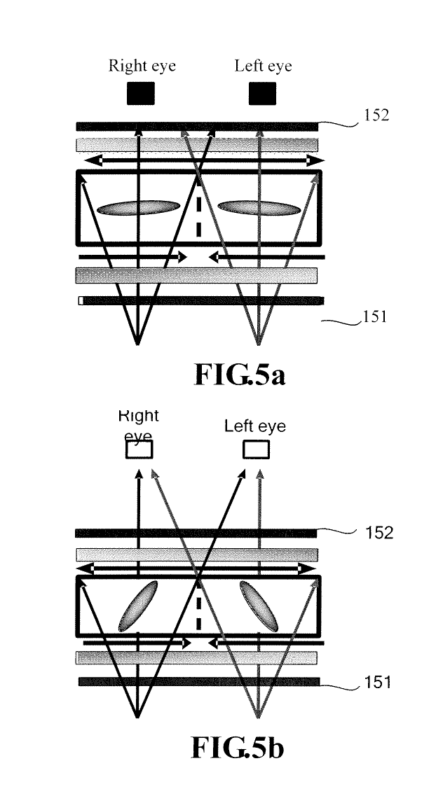

When a voltage difference between the upper substrate 120 and the lower substrate 110 of the display panel of the autostereoscopic display device in the first embodiment is zero, the liquid crystal molecules between the upper substrate 120 and the lower substrate 110 basically have their OA of the liquid crystal molecules parallel with the upper substrate 120 and the lower substrate 110 (it is also possible to have a pretilt angle, e.g., 2°), as shown in FIG. 2. Since the left sub-pixel unit 130L and right sub-pixel unit 130R divided from the pixel unit shown in FIG. 2 are left-right symmetrical, to simplify the description, the right sub-pixel unit 130R in the pixel unit will be taken as an example hereinafter (for descriptions of the left sub-pixel unit 130L, reference may be made to a mirror symmetry of the right sub-pixel unit 130R). Hereinafter, references to FIG. 5a and FIG. 5b will be based on FIG. 4 and discussed in regards to the right sub-pixel unit.

FIG. 4 is a schematic diagram illustrating a relation between the voltage applied to the display panel of the autostereoscopic display device in the first example and the transmittance. FIG. 5a and FIG. 5b are schematic diagrams illustrating operational principles of the autostereoscopic display device according to the first example, when no voltage difference or a voltage difference is applied to the display panel thereof, respectively.

In the prior art, a liquid crystal molecule may be seen as a minute light valve. The transmittance T that light transmits through the liquid crystal layer 130 meets the following equation:

$$T = \frac{1}{2} ( {sin}^{2} 2 φ ) ( {sin}^{2} \frac{Γ}{2} ) \qquad ( 1 )$$

In the above equation, φ denotes an angle between the OA of the liquid crystal molecules and the transmittance axis of the polarizer, and Γ denotes a phase difference and meets the following equation:

Γ=2π(Δn)d/λ (2)

In equation (2), λ denotes a wavelength of incident light, Δn denotes a birefringence coefficient of the liquid crystal, and d denotes a thickness of the liquid crystal layer.

Preferably, in equation (1), when φ is 45° or 135°, i.e. when the light emitted by the backlight source successively passes the 45° lower polarizer 151 on the exterior surface of the lower substrate 110 and the 135° upper polarizer 152 on the exterior surface of the upper substrate 120, the light passing through the liquid crystal layer 130 has a relatively high transmittance. In addition, in equation (1), when Γ equals to (2k+1)π, the light passing through the liquid crystal layer 130 has a high transmittance. Thus, a light path difference (Δn)d of the light passing through the liquid crystal layer 130 is approximately at least λ/2.

Furthermore, in order to compensate for the minimum light path difference λ/2 generated when the light passes through the liquid crystal layer 130, a lower quarter wave plate 141 and an upper quarter wave plate 142 are respectively configured on the exterior surface of the lower substrate 110 and the exterior surface of the upper substrate 120.

When a voltage is applied to the liquid crystal layer 130, there will be an angle θ between the OA of the liquid crystal molecules and the plane where the display panel is located. When different electric fields are applied to the liquid crystal layer, the liquid crystal molecules will have different arrangements (i.e., with different angles θ), which results in a change of the transmittance of the light, as shown in FIG. 5a and FIG. 5b based on FIG. 4.

FIG. 5a is a schematic diagram illustrating an operational principle of the autostereoscopic display device according to the first example when there is no voltage difference applied to the display panel thereof. It shows the arrangement of liquid crystal molecules in the left sub-pixel unit and in the right sub-pixel unit in the liquid crystal layer (for clarity, only one liquid crystal molecule in the right sub-pixel unit is taken as an example in the following description, the liquid crystal molecules in the left sub-pixel unit work in a mirror symmetrical manner with the liquid crystal molecule in the right sub-pixel unit). In the prior art, when a viewer watches the display screen, the sense of the brain to the displayed image is evaluated by a following equation:

Y=AX^{γ} (3)

The equation (3) is the well-known γ emendation equation, in which γ denotes brightness, X denotes the sense of the brain, and A is a constant representing a direct proportion. The sense of the viewer's brain is in a positive correlation with the brightness, i.e., the sense of the brain is approximately in direct proportion to 1/γ-th power of brightness, and the value of 1/γ is about between 0.4 and 0.45.

In the autostereoscopic display device according to the first example, the pixel electrode (not shown) of the display panel 100 is applied with a voltage. The voltage can control the arrangement of the liquid crystal molecules in the liquid crystal layer 130 and thus control the transmittance of the backlight incident to the liquid crystal layer 130 of the display panel 100. Since the brightness of the display panel 100 is in positive correlation with the transmittance of the backlight emitted out from the display panel, the sense of the viewer's brain is also in positive correlation with the transmittance. Accordingly, a grayscale of the image watched by the viewer may also be measured by the transmittance. Specifically, a relation between the transmittance of the light passing through the liquid crystal layer and the voltage applied to the liquid crystal layer may be shown by a transmittance-voltage curve in FIG. 4.

As shown in FIG. 4, curve T1 represents a transmittance-voltage curve of light emitted from the right sub-pixel unit and received by the right eye of the viewer, and curve T2 represents a transmittance-voltage curve of light emitted from the left sub-pixel unit and received by the left eye of the viewer when a view angle (the view angle is defined as an angle between line of sight of the viewer and a normal of the plane of the display panel) is 30° (of course, the view angle here is not limited to 30°, only exemplary data are provided).

Since the liquid crystal molecules will be rotated when a voltage is applied to the liquid crystal layer 130, an angle θ will be generated between the OA of the liquid crystal molecules and the plane where the display panel is located. Different electric fields applied to the liquid crystal layer will result in different arrangements (i.e., different angle θ) of the liquid crystal molecules and therefore result in a change of the transmittance of the light. Preferably, the liquid crystal molecules in this example are positive liquid crystal, which makes the OA of the liquid crystal molecules align with the electric filed direction.

As shown in FIG. 5a, when there is no voltage applied to the liquid crystal layer 130, the OA of the liquid crystal molecules is generally parallel with the plane where the display panel is located (there may also be a small pretilt angle, e.g., 2°). Since the phase difference of the liquid crystal layer compensates the phase difference of two quarter wave plates (i.e., the lower quarter wave plate 141 and the upper quarter wave plate 142), the total phase difference is 0. Therefore, the incidence light basically does not pass through the display panel. In this situation, i.e., when no voltage is applied to the liquid crystal layer, neither the left eye nor the right eye of the viewer can see any image.

As shown in FIG. 5b, when there is a relatively large voltage difference (about 4.8v) between the upper substrate and the lower substrate of the display panel 100, a relatively large twist angle will be generated between the OA of the liquid crystal molecules and the plane where the display panel is located. Thus, the incident light will travel towards the OA direction of the liquid crystal molecules and generally will not travel along the direction perpendicular to the optical axis of the liquid crystal molecules. Referring to FIG. 5b based on FIG. 3, the right image in the right sub-pixel unit is perceived by the right eye of the viewer but will not be perceived by the left eye of the viewer. Similarly, the left image in the left sub-pixel unit will be perceived by the left eye of the viewer but will not be perceived by the right eye of the viewer. Under this situation (i.e. when voltage is applied to the liquid crystal layer), there is basically no crosstalk between the left eye and the right eye of the viewer.

The right sub-pixel unit in the pixel unit is taken as an example for verification. When a relatively large voltage (e.g. about 4.8v) is applied merely to the right sub-pixel unit, the obtained verification result is shown in FIG. 4. The curve T1 of the light entering into the right eye of the viewer has a high transmittance, whereas the curve T2 of the light entering into the left eye of the viewer has a transmittance of almost 0, at this applied voltage.

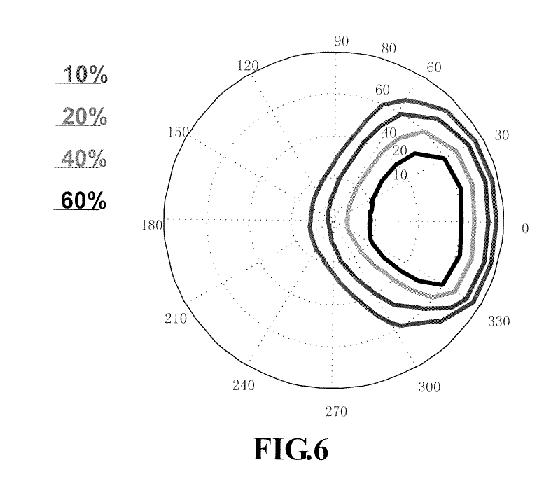

Then referring to FIG. 6, which is a schematic diagram illustrating a verification effect of the autostereoscopic display device of the first embodiment. In order to make the verification effect more apparent, no voltage is applied to the left sub-pixel unit of the display panel 100 of the autostereoscopic display device and a voltage of 4.8v is applied to the right sub-pixel unit. It is clear from FIG. 6 that, contours representing brightness are mostly concentrated in a right half area denoting the right sub-pixel unit, whereas almost no contour representing brightness is distributed in a left half area denoting the left sub-pixel unit. Referring to FIG. 4 again, when the voltage applied to the liquid crystal layer is larger than 4.8v, it can be seen from the curve T1 representing a transmittance-voltage relation of the light emitted from the right sub-pixel unit and received by the right eye of the viewer and the curve T2 representing the transmittance-voltage relation of the light emitted from the left sub-pixel unit and received by the left eye of the viewer that, T1 and T2 respectively correspond to a relatively large transmittance value, i.e. there are lights which will illuminate both the left sub-pixel unit and the right sub-pixel unit at the same time. Therefore, the left eye of the viewer will see the left image and the right image at the same time (similarly, the right eye of the viewer will also see the right image and the left image at the same time). Thus, a crosstalk is generated. Therefore, in order to ensure that there is no crosstalk between the left image and the right image, a voltage of about 4.8 V (in this example) should be applied to the liquid crystal layer, as well as the autostereoscopic display device has the maximum transmittance.

The detailed structure and operational principle of the right sub-pixel unit in the autostereoscopic display device according to this example have been described in detail. Since the left sub-pixel unit is mirror symmetrical with the right sub-pixel unit, the structure and operational principle of the left sub-pixel unit may be obtained by referring to mirror symmetry of the right sub-pixel unit.

Referring to FIG. 3, which is a schematic diagram illustrating an optical effect of the autostereoscopic display device according to the first example, left images 1 and right images 2 are arranged alternatively on the display panel. A backlight source (not shown in FIG. 3) disposed behind the display screen emits light to illuminate the left images 1 and the right images 2 on the display panel. After being refracted by the lenticular array having multiple lens units (or by a barrier array having multiple barrier units) in front of the display screen, the light illuminating the left images 1 and the light illuminating the right images 2 respectively emerge as light 6 in a first direction and as light 7 in a second direction, after appropriate voltage is applied to the liquid crystal layer. The light 6 in the first direction and the light 7 in the second direction are respectively received by the left eye and the right eye of the viewer, while leakage lights 3′ and 4′ in the prior art are suppressed.

Through the above detailed descriptions, it can be seen that the autostereoscopic display device in the first embodiment effectively reduces the light leakage between the left image and the right image and thus reduces the crosstalk to some extent.

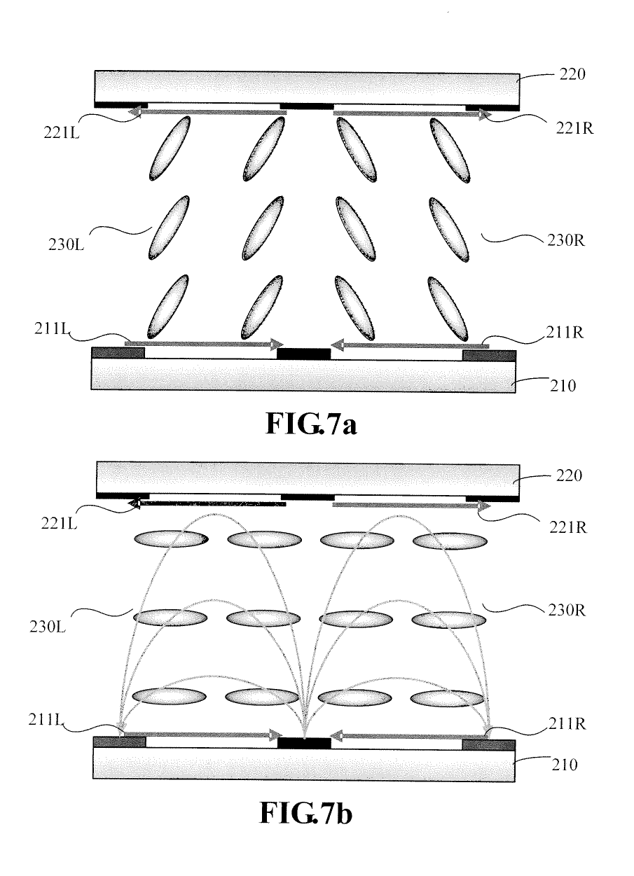

The display panel of the autostereoscopic display device of the present invention may be an In-Plane Switching (IPS) display panel. The IPS display panel includes a pixel electrode and a common electrode configured on a side of a lower substrate 210 which is close to the liquid crystal layer. The pixel electrode and the common electrode are called as horizontal electrodes in general. As shown in FIG. 7a, alignment layers are respectively coated on interior surfaces of an upper substrate 220 and the lower substrate 210 of the IPS display panel of the autostereoscopic display device according to a second example.

In a left sub-pixel unit and a right sub-pixel unit of a same pixel unit, the alignment layers have opposite alignment directions, as shown by an alignment direction of the low alignment layer represented by arrow 211L and an alignment direction of the lower alignment layer represented by arrow 211R in the same pixel unit (or as shown by an alignment direction of the upper alignment layer represented by arrow 221L and an alignment direction of the upper alignment layer represented by arrow 221R). The two alignment directions in the same pixel unit divide the pixel unit into a left sub-pixel unit 230L and a right sub-pixel unit 230R, and liquid crystal molecules in the left sub-pixel unit 230L and in the right sub-pixel unit 230R have different alignment directions. Preferably, when no voltage is applied to the liquid crystal layer, the liquid crystal molecules in the left sub-pixel unit 230L and the liquid crystal molecules in the right sub-pixel unit 230R respectively have pretilt angles due to the function of the alignment layers. Since the liquid crystal molecules in the left sub-pixel unit 230L and in the right sub-pixel unit 230R have different alignment directions, they have opposite pretilt angles. Preferably, according to equation (1), in order to make the backlight passing through the liquid crystal layer have a maximum transmittance, supposing an angle cp between the OA of the liquid crystal molecules and the transmission axis of the polarizer is 45° or 135°, the refractive indices of the liquid crystal molecules are about 1.5 subject to its material in this example. When the backlight emits from back of the liquid crystal display panel into the liquid crystal layer and then emits out of the display panel from the liquid crystal layer, supposing the refractive index of air is approximately 1, then according to the Snell's law,

$$\frac{{n}_{incidence}}{{n}_{refraction}} = \frac{sin {α}_{refraction}}{sin {α}_{incidence}} \qquad ( 4 )$$

according to α_{incidence} which is approximately 45°, n_{incidence}=1 and n_{refraction} is about 1.5, it can be calculated that α_{refraction} is about 63°, i.e., when the pretilt angle of the liquid crystal molecules is about 63°, the display panel has the maximum transmittance in the 45° direction. The angle between the alignment direction of the liquid crystal molecules and the horizontal electrode direction is 45°, i.e. the horizontal electrode is parallel with the transmittance axis of either of the upper polarizer or the lower polarizer.

Under this case, since the optical axis (i.e., the OA) of the liquid crystal molecules in the right sub-pixel unit faces left, the phase difference corresponding to the left direction is approximately 0 and the transmittance is also 0, while the light path difference on the right direction is approximately a half of the wavelength, i.e., Γ=π, then the transmittance maximizes. Therefore, the right image in the right sub-pixel unit 230R is irradiated by light and received by the right eye of the viewer but will not be irradiated by light and received by the left eye of the viewer. Similarly, the left image in the left sub-pixel unit 230L is irradiated by light and received by the left eye of the viewer but will not be irradiated by light and received by the right eye of the viewer. Under this case (i.e., when no voltage is applied to the liquid crystal layer), the viewer sees a complete image of the pixel unit and there is no crosstalk between the left eye and the right eye.

As shown in FIG. 7b, when a voltage is applied to the electrode on the lower substrate of the IPS display panel, the OA of the liquid crystal molecules in the left sub-pixel unit and the OA of the liquid crystal molecules in the right sub-pixel unit are both parallel with the transmittance axis of the polarizer. Then according to the equation (1), it can be obtained that φ=0 and T=0. Therefore, the incident light almost does not pass through the display panel. That is to say, under this case, i.e., when voltage is applied to the liquid crystal layer, neither the left eye nor the right eye of the viewer can see any image. Herein, the method for configuring different alignment directions for the left sub-pixel unit and the right sub-pixel unit are well-known for those skilled in the art and will not be repeated herein.

The foregoing descriptions are of only some examples of the invention and are not to be construed as limiting the protection scope thereof. Any changes and modifications can be made by those skilled in the art without departing from the spirit of this invention and therefore should be covered within the protection scope as set by the appended claims.

1. An autostereoscopic display device, comprising:
a display panel and a backlight source;
the display panel comprising an upper substrate and a lower substrate disposed opposite to each other, and a liquid crystal layer between the upper substrate and the lower substrate and comprising a plurality of liquid crystal molecules;
the backlight source is to provide light to the display panel; and
wherein the display panel comprises
a plurality of pixel units and each pixel unit comprises a first sub-pixel unit and a second sub-pixel unit,
liquid crystal molecules in the first sub-pixel unit have an opposite alignment direction with respect to liquid crystal molecules in the second sub-pixel unit, and
the light is emerged in a first direction after passing through the liquid crystal molecules in the first sub-pixel unit of the display panel and is emerged in a second direction after passing through the liquid crystal molecules in the second sub-pixel unit.

2. The autostereoscopic display device of claim 1, further comprising a lenticular array in front of the display panel, wherein the lenticular array comprises a plurality of lens units.

3. The autostereoscopic display device of claim 2, wherein the upper substrate comprises a common electrode, the lower substrate comprises a pixel electrode, and when no voltage is applied to the liquid crystal layer, an optical axis of the liquid crystal molecules is substantially parallel with the upper substrate and the lower substrate, and the light from the backlight source is substantially blocked from passing through the liquid crystal layer.

4. The autostereoscopic display device of claim 3, wherein when a voltage of 4.8 V is applied to the liquid crystal layer, the autostereoscopic display device has the maximum transmittance and no crosstalk.

5. The autostereoscopic display device of claim 2, further comprising an upper polarizer on an exterior surface of the upper substrate and a lower polarizer on an exterior surface of the lower substrate.

6. The autostereoscopic display device of claim 5, further comprising an upper quarter wave plate between the upper substrate and the upper polarizer, and a lower quarter wave plate between the lower substrate and the lower polarizer.

7. The autostereoscopic display device of claim 1, wherein image information displayed by the first sub-pixel unit is different from image information displayed by the second sub-pixel unit.

8. The autostereoscopic display device of claim 1, wherein the display panel is in an In-Plane Switching structure, and when no voltage is applied to the display panel, there is a pretilt angle of 63°.

9. The autostereoscopic display device of claim 1, further comprising a barrier array configured in front of the display panel, wherein the barrier array comprises a plurality of barrier units.

10. The autostereoscopic display device of claim 9, wherein the upper substrate comprises a common electrode, the lower substrate comprises a pixel electrode, and when no voltage is applied to the liquid crystal layer, an optical axis of the liquid crystal molecules is substantially parallel with the upper substrate and the lower substrate, and the light from the backlight source is substantially blocked from passing through the liquid crystal layer.

11. The autostereoscopic display device of claim 10, wherein when voltage of 4.8 V is applied to the liquid crystal layer, the autostereoscopic display device has the maximum transmittance and no crosstalk is generated.

12. The autostereoscopic display device of claim 9, further comprising: an upper polarizer on an exterior surface of the upper substrate and a lower polarizer on an exterior surface of the lower substrate.

13. The autostereoscopic display device of claim 12, further comprising an upper quarter wave plate between the upper substrate and the upper polarizer, and a lower quarter wave plate between the lower substrate and the lower polarizer.
